(19) United States
(12) Patent Application Publication
(10) Pub. No.: US 2019/0016368 A1
(43) Pub. Date: Jan. 17, 2019

(54) RACK-AND-PINION GEAR FOR A MOTOR VEHICLE

(71) Applicant: FORD GLOBAL TECHNOLOGIES, LLC, Dearborn, MI (US)

(72) Inventor: Kianmin DJIE, Cologne NRW (DE)

(73) Assignee: FORD GLOBAL TECHNOLOGIES, LLC, Dearborn, MI (US)

(21) Appl. No.: 16/022,095

(22) Filed: Jun. 28, 2018

(30) Foreign Application Priority Data
Jul. 14, 2017 (DE) 10 2017 212 073.8

(51) Int. Cl. B62D 3/12; F16H 55/28

(52) U.S. Cl. CPC B62D 3/123; F16H 55/283

(57) ABSTRACT

A rack-and-pinion steering gear for a motor vehicle allows adjustment of an inclination angle between the rack and pinion at the point of contact therebetween to reduce noise. A yoke is spring-biased against the rack to urge rack into engagement with the pinion. The yoke is supported in a bushing which can be adjusted within and relative to a housing such that the yoke moves in a plane parallel to a longitudinal axis of the rack and to a longitudinal axis of the pinion shaft. The yoke engages the rack to permit steering-type movement of the rack relative to the yoke along the rack longitudinal axis, but movement of the yoke parallel to the pinion shaft longitudinal axis forces the portion of the rack contacting the yoke to move along with the yoke, thereby adjusting the inclination angle between the rack and the pinion.

### CROSS-REFERENCE TO RELATED APPLICATIONS

This application claims foreign priority benefits under 35 U.S.C. § 119(a)-(d) to DE Application 10 2017 212 073.8 filed Jul. 14, 2017, which is hereby incorporated by reference in its entirety.

### TECHNICAL FIELD

The invention relates to a rack-and-pinion gear for a motor vehicle, having a pinion shaft and a toothed rack which are supported inside a housing, wherein a spring-biased yoke forces the rack toward the pinion shaft.

### BACKGROUND

In steering gears of motor vehicles, in particular passenger vehicles, a rack-and-pinion steering is normally used. In this instance, a pinion shaft which is rotated by means of the steering wheel cooperates with a toothed rack which in turn acts on the tie rods. The rack is pressed by means of a resilient yoke against the toothed pinion of the pinion shaft. In this instance, both the pinion shaft and the rack are arranged at least partially inside a steering rack-and-pinion gear housing in which they are rotatably or displaceably guided. In order to enable an optimum interlocking of the pinion with the rack, particularly small tolerances have to be complied with during the production. This relates, on the one hand, for example, to an inclination angle of the pinion relative to the rack, on the other hand, to the production of the steering gear housing. Particular attention should be paid in this instance to the angle at which the pinion shaft engages on the rack, in particular the proportion thereof which is projected onto the Y-Z plane which is also referred to as a tower angle. If the inclination of the pinion shaft with respect to the rack is not adjusted in an optimum manner, this may, for example, lead to undesirable rattling noises or also to excessive friction and wear. However, complying with the corresponding tolerances is complex and leads to increased production costs.

US 2014/0026694 A1 discloses a rack-and-pinion steering with a yoke which is pressed along a pressure axis against a rack. The yoke has a guide for the rack along the rack axis thereof, wherein there is provided an adjustment device for adjusting the guiding of the yoke along an adjustment axis which extends at an angle relative to the pressure axis and to the rack axis. In this instance, the guide may be formed on an adjustment portion which is connected to a rotationally movable rotary component by means of a cam. By rotating the rotary component, a positional change of the adjustment component and consequently of the guide is carried out.

US 2012/0248724 A1 sets out a rack-and-pinion drive for a vehicle steering system in which a toothed rack cooperates with a pinion. At two ends of a housing which are opposed with respect to the pinion, the rack is retained by means of a retention member. Furthermore, there is provided a yoke which acts on the rack with a force. In this instance, the direction of the action of the force is such that a component acts in the direction toward the pinion shaft, whilst another component acts transversely relative thereto, whereby it is possible for the rack to be in abutment with the respective retention member above or below the tooth arrangement.

U.S. Pat. No. 8,555,741 B2 sets out a rack-and-pinion drive in which a toothed rack cooperates with a pinion, wherein both are arranged inside a housing. There is provided a bearing ring in which the rack is supported. In this instance, an inner contour of the bearing ring is formed eccentrically relative to an outer circumference. A similar construction is known from U.S. Pat. No. 7,775,135 B2.

DE 100 04 710 A1 discloses a rack-and-pinion steering gear having a drive pinion which is rotatably supported in a steering housing and which engages in a rack which can be axially displaced in the steering housing. The steering gear has a bearing which is constructed as a yoke and which has an eccentric bearing shell which presses the rack against the drive pinion.

U.S. Pat. No. 7,654,166 B2 discloses another rack-and-pinion drive in which a rack is acted on with force by means of a yoke in the direction toward a pinion.

In view of the prior art set out, ensuring an optimal engagement between a pinion shaft and a rack still leaves room for improvement. In particular, it would be desirable to optimize the production costs without impairing the precision.

### SUMMARY

It should be noted that the features and measures set out individually in the following description can be combined with each other in any technically advantageous manner and set out other embodiments of the invention. The description additionally characterizes and specifies the invention in particular in connection with the Figures.

A rack-and-pinion steering gear for a motor vehicle is provided. The motor vehicle may, for example, be a passenger vehicle or a truck. The rack-and-pinion gear has in this instance a pinion shaft and a toothed rack which are supported inside a housing. In the case of a steering gear, there is provision for the pinion shaft to be at least indirectly connected to a steering wheel. The pinion shaft has a pinion having a circumferential tooth arrangement which cooperates with a corresponding single-sided tooth arrangement on the rack. A straight tooth arrangement or an oblique tooth arrangement may be used. Both the pinion shaft and the rack are supported inside a housing, wherein the pinion shaft is rotatably supported, whilst the rack is displaceably supported along the longitudinal axially direction thereof

In this instance, a yoke is biased (by for example a coil spring) to press against the rack to urge the teeth thereof into engagement with the teeth of the pinion. The yoke is biased by means of a resilient element (such as a coil spring) and supported together with this resilient element in the housing. The biasing causes the yoke to apply a force to the rack in the direction toward the pinion shaft. The yoke is preferably constructed in an integral manner. Preferably, the yoke is arranged to contact a surface of the rack opposite of the pinion shaft. However, embodiments are also conceivable in which no separate resilient element is provided, but instead the biasing force is produced by a resilient deformation of the yoke itself. The yoke has a guide face in contact with the rack which is configured to engage the rack in a manner permitting sliding displacement of the rack along the longitudinal axis thereof. The guide face forms with the rack a partial positive-locking connection by means of which displacements of the rack relative to the yoke transversely to the rack's longitudinal axis thereof are minimized or prevented.

According to the invention, the yoke is supported in a bearing component or bushing which can be movably adjusted within and relative to the housing in such a manner that the position of the yoke within the housing is also adjusted. There is thus provided a bushing in which the yoke is supported in such a manner that it can be displaced in a pressure direction (with respect to the bushing component). In other words, as long as a position or movement of the rack permits, the yoke can be displaced inside the bushing component in the pressure direction. This results in the bushing component not undergoing any corresponding displacement in the pressure direction; it could, for example, be locked in this direction with respect to the housing. However, the bushing component can be adjusted within and with respect to the housing in such a manner that a position of the yoke with respect to the housing can thereby be adjusted at an angle relative to the pressure direction and the extent direction of the rack. The adjustment is thus carried out neither parallel with the pressure direction, nor parallel with the extent direction. In this instance, the term “adjustable” is intended to mean that the position of the yoke can be predetermined within a tolerance range which is of course always present.

Preferably, the bushing component is also constructed in one piece, but multi- component constructions are also conceivable. The yoke may be supported directly within the bushing component or where applicable also indirectly, by means of at least one intermediate element.

As a result of the adjustability of the position of the yoke according to the invention, it is possible to adjust an inclination of the rack with respect to the pinion shaft. This results from the fact that the yoke guides or moves the portion or location of the rack where it is engaged by the guide face. The rack is supported at a distance along its longitudinal axis from the pinion shaft (for example, adjacent to the end of the housing distal from the pinion shaft) by means of a bearing. This bearing acts as a support point about which a bending the rack takes place, the bending caused by the movement/adjustment of the yoke perpendicular to the rack longitudinal axis. The portion of the rack which is contacted by the yoke is also displaced along/parallel to the pinion shaft axis, whereby the inclination of the rack relative to the pinion shaft changes slightly. In other words, the precise position of the rack within the housing and the inclination thereof with respect to the pinion shaft are not precisely predetermined by the manufactured geometry of the housing, but instead it is possible to adjust them—normally during the assembly—in such a manner that an optimal interlocking between the respective teeth of the pinion shaft and the rack is achieved. If the inclination is characterized by a (one or two-dimensional) angular range, as a result of the adjustment there is predetermined a specific angular range which changes depending on the adjustment. For example, the inclination with respect to an appropriately selected axis could be at a setting between 0° and 1° whilst in another setting it is between 3° and 4°. In particular, it is thereby possible in the case of a steering gear to also influence the tower angle, that is to say, the projection of the angle between the pinion shaft and the rack on the Y-Z plane.

During the assembly, the ideal adjustment can be verified, for example, by a rolling movement of the rack or an available play of the yoke being monitored.

As a result of the adjustment possibility mentioned, the housing and, where applicable, also other components can be produced with less precise dimensional tolerance, whereby the production costs can be reduced. Any additional costs as a result of the bushing component may in contrast be comparatively small, as will be made clear below with reference to individual embodiments.

Preferably, the yoke is supported inside a through-opening of the bushing component. That is to say, the bushing component has a through-opening or recess inside which the yoke is supported. At least a portion of the yoke is arranged inside the through-opening, whereby the yoke is displaceably supported as described above in the pressure direction. Depending on the embodiment, the yoke may protrude completely through the through-opening or it may only protrude therein. In this instance, it is possible for a resilient element, by means of which the biasing is produced on the yoke, to also protrude partially into the through-opening and to be in abutment therein with the yoke. More generally, the resilient element and the yoke may be arranged at least partially on opposing sides of the through-opening. In the embodiment described in this instance, it is particularly readily possible to decouple the bushing component completely from the biasing. As a result of this decoupling, it is under some circumstances more readily possible during the assembly to carry out the adjustment of the bushing component with respect to the housing. It may also be possible to prevent an undesirable adjustment of the bushing component occurring after the assembly as a result of the force of the biasing. It is also not necessary to take any precautions to fix the position of the bushing component in the pressure direction.

Preferably, for example, in the case of a steering gear, the longitudinal axis of the rack is horizontal (parallel with the vehicle Y-axis) and a vertical position of the yoke can be adjusted by means of an adjustment of the bushing component. As already described above, it is thereby possible to change the inclination of the rack relative to the pinion, which can in particular influence the tower angle. Depending on the embodiment, it is possible, as a result of the change of the vertical position, for a change of the horizontal position to also inevitably take place.

According to an advantageous and structurally simple embodiment, the bushing component is constructed as an eccentric bushing which can be arranged with respect to the housing (normally inside the housing) at different angular positions around the yoke. This embodiment can generally also be produced in a particularly cost-effective manner. The bushing in this instance receives the yoke in a hole formed therein. The bushing, which may, for example, be constructed in a cylindrical manner, has an inner contour or hole for (at least indirectly) receiving the yoke and an outer circumference which may be arranged inside the housing and may be, for example, at least partially in positive-locking engagement therewith. The inner contour or hole is in positioned eccentrically (non-concentrically) with respect to the circumference (or vice versa). The inner contour or hole is provided for receiving the yoke and may, for example, have a circular cross-section. The outer circumference could have a polygonal, for example, hexagonal or octagonal, cross-section. On the housing, a corresponding recess with a polygonal cross-section into which the bushing is inserted would then have to be formed. In this instance, in the case of a hexagonal cross-section, the bushing could be arranged in six different angular positions around the yoke, wherein, as a result of the eccentric arrangement of the inner hole with respect to the circumference, the yoke is arranged in each case in a different position with respect to the housing. This in turn leads to a different inclination of the rack with respect to the housing and the pinion shaft. As a result of the change of the angular position, generally not only a position perpendicular relative to the longitudinal axis of the rack is changed, but also a position in the direction of the axial direction. However, the latter is unproblematic since the rack can be freely displaced in this direction to some degree with respect to the yoke.

Preferably, the bushing can be arranged in any angular position. In this instance, the outer circumference or the outer covering face of the bushing has a circular cross-section so that it can be freely orientated within a corresponding recess of the housing. In this manner, it is of course also possible to adjust the position of the yoke parallel with the pinion shaft axis and consequently the inclination of the rack in a more variable manner than with a limited number of orientation possibilities of the bushing. However, with a primarily circular outer cross-section, a wrench flat, for example, an external hexagonal head or the like, may also be partially provided in order to enable a positive-locking connection with a tool, by means of which the bushing is adjusted.

In order to prevent the position of the bushing and consequently the inclination of the rack from being adjusted in an undesirable manner during operation, it is preferable for the bushing to be able to be locked in an angular position inside the housing. With a polygonal cross-section, the bushing is in any case received in the housing in a rotationally secure manner by means of a corresponding positive-locking connection. In contrast, with a circular cross-section, it may be necessary to provide a locking element, for example, a locking screw, which engages laterally on the bushing. In other cases, a locking element may be dispensable, for example, when the friction between the bushing and the housing prevents rotation.

As a result of the displaceability of the yoke inside the bushing component, it is in many cases insignificant if the rotation of the bushing component is associated with a slight displacement in the direction of the rotation axis. Consequently, the adjustment can be carried out by means of a helical movement. According to such an embodiment, the bushing has a thread which cooperates with a counter-thread of the housing. Under some circumstances, there may be produced between the threads a non-positive-locking connection which makes additional locking unnecessary. The thread may be an outer thread so that the bushing is screwed into the housing. Alternatively, however, it would also be conceivable for the thread of the bushing to be an inner thread and the counter-thread to be an outer thread.

As an alternative to the above-described embodiment, in which an eccentric bushing can be arranged in different angular positions, the bushing component can be adjusted in a linear manner with respect to the housing. The bushing component can be continually displaced in a linear manner relative to the housing (preferably inside the housing), wherein embodiments would also be conceivable in which a plurality of discrete linearly sequential positions are possible. The linear displacement may in this instance in particular be a linear displacement, although, for example, a displacement along a curved path would also be conceivable. As a result of the linear displacement of the bushing component, of course, the yoke which is supported therein is also displaced, whereby the provided change of the inclination of the rack is carried out. Generally, this embodiment is structurally slightly more complex than the one with an eccentric bushing, but there is in this instance a more linear connection between the adjustment path and the change of the inclination of the rack which is brought about thereby. In order to prevent an undesirable displacement of the bushing component, for example, a locking element may be provided. On the other hand, it would also be possible for the bushing component to be able to be adjusted via a self-locking drive (for example, spindle drive).

The bushing component is preferably arranged inside a bearing channel formed within the housing. The path of the channel naturally corresponds in this instance to the provided adjustment device and the walls of the bearing channel preferably form a positive-locking connection with the bushing component in order to ensure the guiding thereof. At the end side of the bearing channel, there may be formed stops for the bushing component which correspond to provided extreme positions.

As already indicated, the bushing component can preferably be locked with respect to the housing. To this end, a locking element may in particular be provided, such as, for example, a locking screw, which is screwed through a wall of the housing against the bushing component in order to produce a non-positive-locking connection therewith. Of course, a positive-locking connection could also be produced by means of a securing pin. A materially integral securing would also be conceivable. It would thus be possible, for example, with a bushing with an outer thread to use a fluid screw securing in order to prevent twisting counter to an inner thread of the housing.

Other advantageous details and effects of the invention are explained in greater detail below with reference to different embodiments illustrated in the Figures, in which:

### BRIEF DESCRIPTION OF THE DRAWINGS

FIG. 1 is a perspective illustration of a steering gear according to a first disclosed embodiment;

FIG. 2 is a sectioned illustration of the steering gear of FIG. 1;

FIG. 3 is a sectioned illustration along the line 3-3 in FIG. 2;

FIG. 4 is a sectioned illustration of a steering gear according to a second disclosed embodiment; and

FIG. 5 is a sectioned illustration along the line 5-5 in FIG. 4.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

In the different Figures, identical components are always given the same reference numerals, for which reason they are generally also only described once.

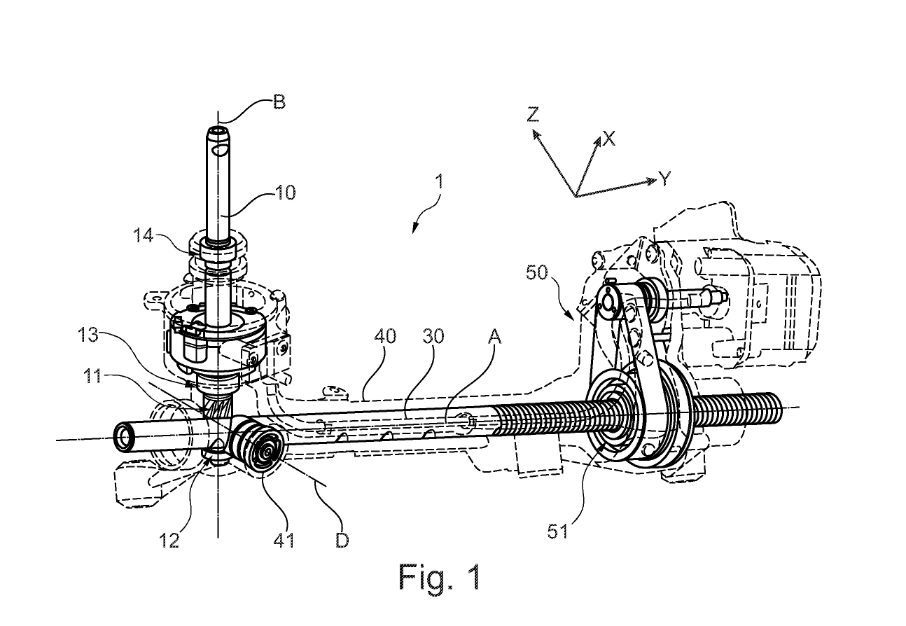

FIGS. 1-3 show a first embodiment of a rack-and-pinion steering gear 1 for a passenger vehicle, wherein FIG. 1 is a perspective illustration of the entire steering gear 1. This comprises a pinion shaft 10 with a toothed pinion 11 adjacent its lower end which cooperates with teeth 31 formed along the length of a rack 30. In the Figures, the X-, Y- and Z-axes of the vehicle (in accordance with the commonly accepted convention in the automotive industry) are drawn in accordance with the provided installation position of the steering gear 1. A longitudinal axis A of the rack 30 is parallel with the Y-axis and consequently horizontal, whilst an axial direction B of the pinion shaft 10 (at least approximately) can extend within the X-Z plane or also at an angle to all three axes. Both the pinion shaft 10 and the rack 30 are supported inside a housing 40. In this instance, the rack 30 is linearly displaceable in the direction of the Y-axis, and the pinion shaft 10 is rotatable about its longitudinal axis B.

The rotatable support of the pinion shaft 10 is produced by means of three bearings 12, 13, 14 or roller bearings which are received in a stationary manner inside the housing 40. Spacing along the rack 30 from the pinion shaft 10 is a servo subassembly 50 which cooperates with the rack 30. The structure and function of the servo subassembly 50 are not significant to the present invention and are thus not explained in greater detail. However, in the region of the servo subassembly 50, there is formed a bearing location 51 for the rack 30 on which it is supported with respect to the housing 40.

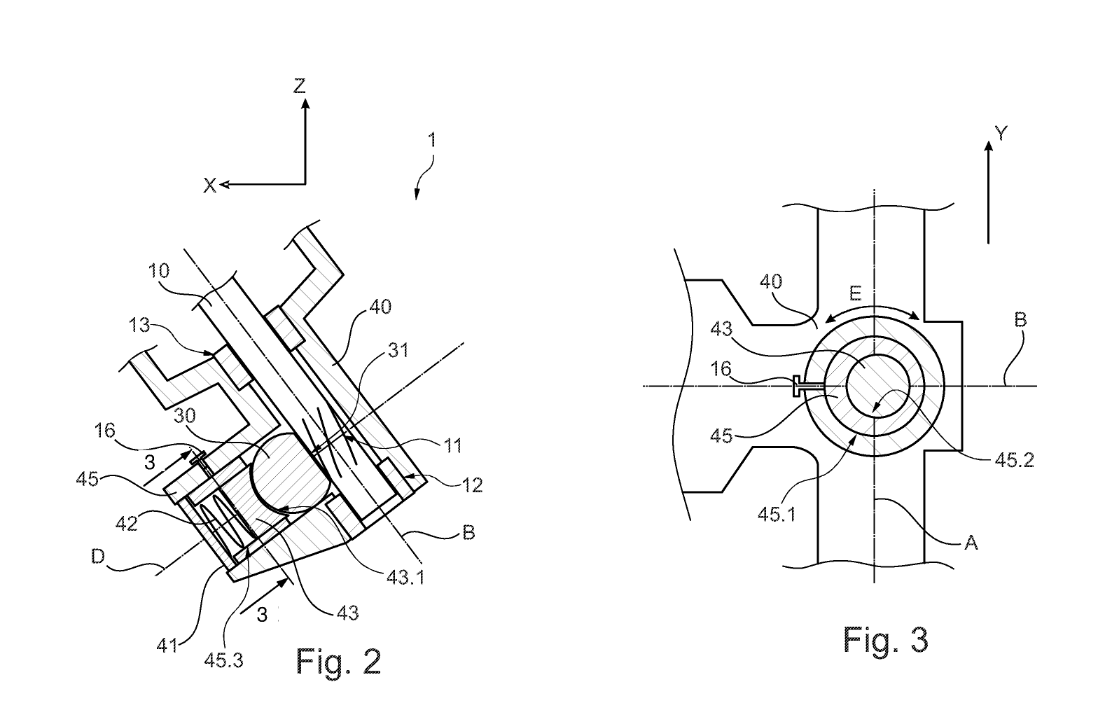

In order to improve the engagement between the rack teeth 31 and the pinion 11, the rack 30 is subjected to pressure by a pressure element or yoke 43 to urge or force the rack toward the pinion shaft 10. The yoke 43 has a cylindrical lateral surface and a guide face 43.1 on the end which contacts and applies pressure to the rack 30. In the depicted embodiment, the guide face 43.1 is concave as viewed along the rack longitudinal axis A as shown in FIG. 2, and circular as viewed along the pressure direction D, so that it conforms to the cylindrical surface of the rack at the area of contact between the two components. The guide face therefore has a “concave cylindrical” surface, defined herein for purposes of description as the surface formed when a concave arc is projected along a line perpendicular to the axis of a cylinder.

The relative configurations of the guide face 43.1 and the surface of the rack 30 contacted thereby create a partial positive-locking connection to the rack 30: The contact or engagement between the yoke 43 and the rack 30 permits the rack to move freely along the longitudinal axis A relative to the yoke (which occurs during normal steering activity), whilst it securely restrains the rack against displacements relative to the yoke in directions transverse to the rack axis A. In the embodiment shown in FIG. 2, the restraining or “locking” effect in the direction parallel with the pinion shaft axis B (and perpendicular to axes D and B in FIG. 2) is provided by the fact that the guide face 43.1 extends around the cylindrical lateral surface of the rack, as seen in FIG. 2.

In spite of the urging of the rack against the pinion, a potential problem involves the engagement between the respective teeth of pinion shaft 10 and rack 30 not being optimum, which may, for example, lead to undesirable rattling noises (NVH). Whether these noises occur is at least in part dependent on the inclination of the pinion shaft 10 inside the housing 40 and with relative to the rack 30. In this instance, small changes of the inclination angle can influence the toothed engagement in a decisive manner.

In order to prevent the housing 40 from having to be manufactured with a relatively high degree of precision (small dimensional manufacturing tolerances), the position of the yoke 43 can be adjusted so as change the inclination angle. More specifically, a position of the yoke 43 parallel to the pinion shaft axis B can be adjusted. To this end, the yoke 43 is supported inside a bushing 45 which has a circular outer circumference 45.1 and a circular inner contour or hole 45.2 which is positioned eccentrically (non-concentrically) relative thereto. As a result of the circular outer circumference 45.1, the bushing 45 can (during manufacture and/or servicing of the steering gear) be rotated within the housing 40 to assume any angular position around the yoke 43. This rotation of the bushing 45 is shown in FIG. 3 by adjustment movement E, indicated by the double-headed, curved arrow. Depending on this rotational/angular adjustment of the bushing, the inner contour/hole 45.2 and consequently the yoke 43 received therein are displaced in a circular manner about the axis of rotation of the bushing 45, which (in the depicted construction) is coaxial with the pressure axis D. Because of the configuration of the engagement between the yoke guide face 43.1 and the surface of the rack 30 (described above), this circular displacement of the yoke 43 within the housing 40 forces the portion of the rack that is contacted by the guide face to move, along with the yoke, in a direction parallel to the pinion longitudinal axis B.

The adjustment operation thus results in a bending or deflection of the rack 30 (of relatively small magnitude) about a support point collocated with the bearing 51, with the bending angle being determined by the magnitude of movement of the yoke 43 along or parallel to the pinion shaft axis B. This bending directly results in a change in the inclination angle of the rack 30 relative to the pinion 11. In the depicted embodiment, any movements of the yoke 43 relative to the housing 40 in the pressure direction D are decoupled from the bushing 45. The yoke 43 can be displaceably arranged in the pressure direction D in the bushing 45, more specifically in a through-opening 45.3 thereof

The rotational adjustment E of the bushing 45 brings about a circular movement of the yoke in the plane of the section shown in FIG. 3, and therefore also causes a displacement of the yoke 43 which has a component along the longitudinal axis A of the rack. This A-axis movement does not contribute to changing the inclination of the rack 30, and does not apply any force to the rack since the rack is able to move freely relative to the yolk 42 along (parallel to) the A-axis.

Under some circumstances, friction between the bushing 45 and the housing 40 may be sufficient to prevent an undesirable rotation of the bushing during operation of the vehicle. If this is not the case, the bushing may be locked with respect to the housing 40 by means of a locking screw 16 after the optimal angular position has been achieved. To facilitate the adjustment of the angular position, the bushing 45 may have at the end side structures for the positive-locking engagement with a tool, for example, an internal hexagon socket or the like.

Whilst the bushing outer circumference 45.1 may be constructed to be smooth, there may alternatively be formed at that location an outer thread which cooperates with a corresponding inner thread on the housing 40. In this instance, under some circumstances it is possible to dispense with the locking screw 16 and if necessary a fluid screw securing can be used.

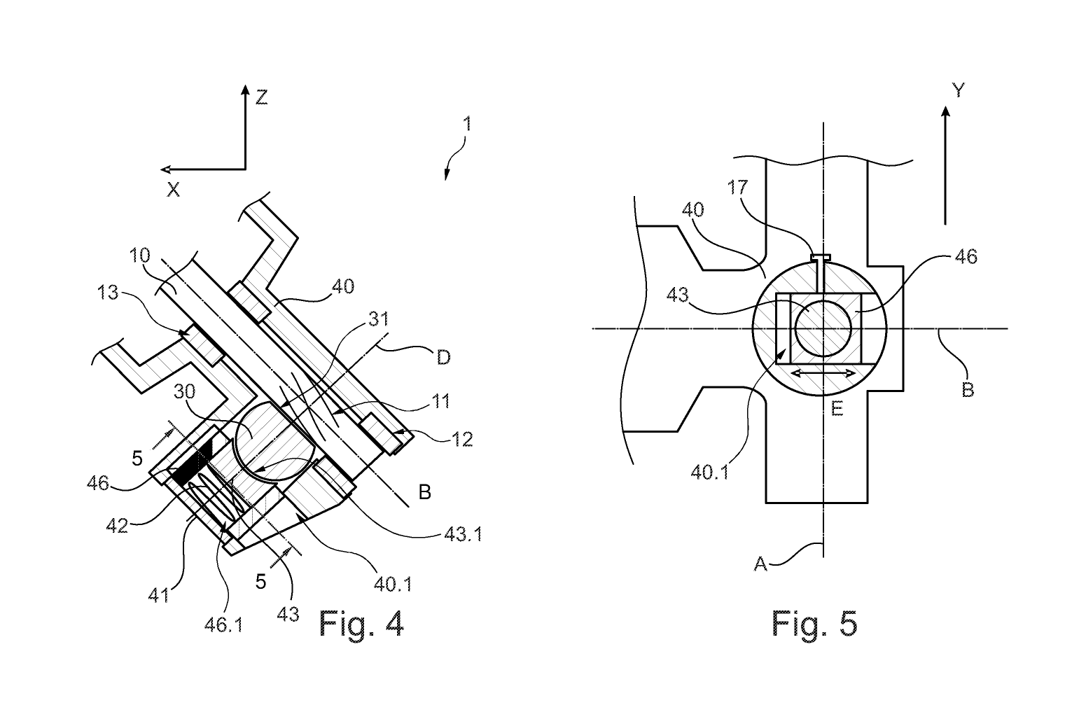

FIGS. 4 and 5 show a second embodiment of a steering gear 1 according to the invention which substantially corresponds to the embodiment shown in FIGS. 1 to 3 and thus will not be explained again. In place of the eccentric bushing 45, the steering gear 1 has a bearing component 46 to support the yoke 43. In a through-opening 46.1 of the bearing component 46, the yoke 43 is displaceably supported in the pressure direction D. The bearing component 46 can be adjusted in a linear manner inside a bearing channel 40.1 of the housing 40, wherein the double-headed arrow E in FIG. 5 indicates the direction of adjustment movement. In this depicted embodiment, the friction forces between the bearing component 46 and the housing 40 may not be sufficient to reliably prevent an undesirable displacement of the bearing component during operation of the vehicle. For this reason, there must generally be provided a locking screw 17 which can be seen in FIG. 5 and by means of which the bearing component 46 is locked after an optimum inclination of the rack 30 has been adjusted.

In this FIGS. 4-5 embodiment, the adjustment of the yoke 43 relative to the rack 30 and housing 40 is always made purely parallel with the axis B of the pinion shaft. This is advantageous in so far as the connection between an adjustment path and the change of the inclination of the rack 30 which is thereby brought about is approximately linear. This is in contrast to the embodiment of FIGS. 2 and 3, where an adjustment of the position of the yoke 43 perpendicularly to the axial direction A of the rack 30 [parallel with the pinion shaft axis B] is necessarily accompanied by an adjustment parallel with the axial direction A.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A rack-and-pinion steering gear, comprising:
a pinion shaft having a toothed pinion adjacent an end thereof;
a rack supported inside a housing and having a toothed surface engaging the pinion;
a cylindrical yoke biased along a pressure axis to press against the rack at a location opposite the pinion and urge the rack into toothed engagement with the pinion, engagement between the yoke and the rack a) allowing movement of the rack relative to the yoke along the rack longitudinal axis during steering and b) restraining against movement of the rack relative to the yoke in an adjustment direction parallel with a pinion shaft longitudinal axis; and
a bushing having a circular outer surface and an eccentrically-positioned inner contour receiving the yoke therein, the bushing retained in the housing and rotatable relative thereto to displace the yoke in a direction having a component in the adjustment direction.

2. The rack-and-pinion steering gear of claim 1, further comprising a coil spring biasing the yoke against the rack.

3. The rack-and-pinion steering gear of claim 1, wherein the bushing is lockable against rotation with respect to the housing.

4. The rack-and-pinion steering gear of claim 1, wherein: a surface of the rack against which the yoke presses is cylindrical, and a face of the yoke pressing against the rack has a concave cylindrical shape conforming to the rack.

5. A rack-and-pinion gear, comprising:
a cylindrical yoke biased along a pressure axis to urge a rack against a pinion; and
a component having a circular circumference and an eccentrically-positioned inner contour receiving the yoke therein, and rotatable within a rack housing to displace the yoke in a plane perpendicular to the pressure axis and thereby move a yoke-contacting portion of the rack parallel to a longitudinal axis of the pinion.

6. The rack-and-pinion gear of claim 5, further comprising a coil spring biasing the yoke against the rack.

7. The rack-and-pinion gear of claim 5, wherein the component is lockable against rotation with respect to the rack housing.

8. The rack-and-pinion steering gear of claim 5, wherein: a guide face of the yoke pressing against the rack has a concave cylindrical shape conforming to a cylindrical surface of the yoke-contacting portion of the rack.

9. A rack-and-pinion gear, comprising:
a yoke biased along a pressure axis against a portion of the rack to urge the rack into toothed engagement with a pinion, and movable perpendicular to the pressure axis to force the portion along an adjustment axis parallel with a longitudinal axis of a pinion shaft; and
a component movable within a rack housing to displace the yoke in a direction having a component along the adjustment axis.

10. The rack-and-pinion gear of claim 9, further comprising a coil spring biasing the yoke against the rack.

11. The rack-and-pinion gear of claim 9, wherein:
the yoke is cylindrical; and
the component has a circular outer surface and an eccentrically-positioned inner contour receiving the yoke therein, the component retained within the housing and rotatable relative thereto to displace the yoke.

12. The rack-and-pinion steering gear of claim 11, wherein: a guide face of the yoke pressing against the rack has a concave cylindrical shape conforming to a cylindrical surface of the rack against which the guide face presses.

13. The rack-and-pinion gear of claim 11, wherein the component can be locked against rotation with respect to the housing.

14. The rack-and-pinion gear of claim 9, wherein the component is linearly adjustable relative to the housing.
